(19) United States
(12) Patent Application Publication
(10) Pub. No.: US 2006/0292911 A1
(43) Pub. Date: Dec. 28, 2006

(54) Connector

(75) Inventor: Kuang-Hui Ning, Taipei (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Compal Electronics, Inc.

(21) Appl. No.: 11/281,615

(22) Filed: Nov. 18, 2005

(30) Foreign Application Priority Data
Jun. 28, 2005 (TW) 094210850

(51) Int. Cl. H01R 13/15

(52) U.S. Cl. 439/260

(57) ABSTRACT

The present invention relates to a connector, especially to a connector for connecting a flexible flat cable (FFC). By providing a pivoting member and positioning members on a base and a pivoted member and positioned member on a top cover, the FCC can be fixed and positioned at a proper position between the base and the top cover.

### BACKGROUND OF THE INVENTION

1. Field of the Invention

The present invention relates to a connector, and more particularly to a connector for fixing a flexible flat cable (FFC) or a flexible printed circuit (FPC).

1. Description of the Related Art

Connectors are commonly used in electronic products, and a flexible flat cable (FFC) and a flexible printed circuit (PFC) are introduced to meet the requirements for a circuit connection and a space layout. When the corresponding FCC or PFC connector is used, the effect of the circuit connection can be maximized. Therefore, the FFC and FPC are used extensively in the products such as keyboards, notebook computers, mobile phones and facsimile machines, etc.

As implied in the name, connectors have a main function of connecting or relaying a signal and/or a power supply. Therefore, a connector is provided for securely connecting an object which is usually a circuit board. If the connection is improper, then the signal or power supply will be disconnected. The key point of the design is focused on a secured connection.

R.O.C. Pat. Application No. 92213446 entitled “Electric connector” discloses a connector having a reinforced arm and a T-shaped groove disposed on a metal casing, and a T-shape protrusion corresponding to the T-shape groove disposed on a base, such that when a latch is connected, the connector can be secured. However, such patent has not taken the constant connection into consideration, when the terminals of the circuit board are plugged. The FFC cannot be guided into a proper position and the FFC is not plugged or fixed properly, or one side of the FFC is tilted. As a result, the circuit will have a poor contact or will even be shorted. Therefore, the FFC has to be reinstalled or plugged again. Additional manpower is needed to examine whether or not the connection or the signal is correct. The abovementioned situation occurs very often, if the pitch of the connector or the number of pins of the FFC gets smaller.

### SUMMARY OF THE INVENTION

The primary objective of the present invention is to provide a connector that precisely and securely fixes a flat cable between the base and the upper casing of the connector, so as to achieve the purpose of clamping the flat cable. With the installation of the foregoing upper casing and base, the components are interfered and latched with each other, and a component is disposed at the corresponding position of the flat cable for passing the flat cable through. When the upper casing is engaged with the base, the upper casing will not be loosened or fallen out due to the interference and latch, so as to achieve the effect of precisely fixing the upper casing into a position.

To achieve the foregoing objective, the present invention provides a connector to be installed onto a flat cable and comprises a base having a plurality of terminal slots disposed at an operating end for receiving a plurality of terminals, and a pivoting member disposed separately on both sides of the base, and a positioning member disposed on both external sides of the terminal slots, and an upper casing having a pivoted member pivotally coupled with the pivoting member, and a positioned member disposed at a position corresponding to the positioning member, such that the flat cable is clamped between the base and the upper casing by a penetrating groove disposed corresponding to the positioning member, and the positioned member passes through the penetrating groove to couple with the positioning member.

### BRIEF DESCRIPTION OF THE DRAWINGS

FIG. 1 is an exploded view of a preferred embodiment of the invention;

FIG. 2 is a schematic view of an upper casing being pivotally coupled to a base according to the invention;

FIG. 3 a schematic view of a flexible flat cable being plugged according to the invention;

FIG. 4 is a cross-sectional view of an upper casing and a base being installed according to the invention; and

FIG. 5 is a cross-sectional view of a flexible flat cable being plugged according to the invention.

### DETAILED DESCRIPTION OF THE PREFERRED EMBODIMENTS

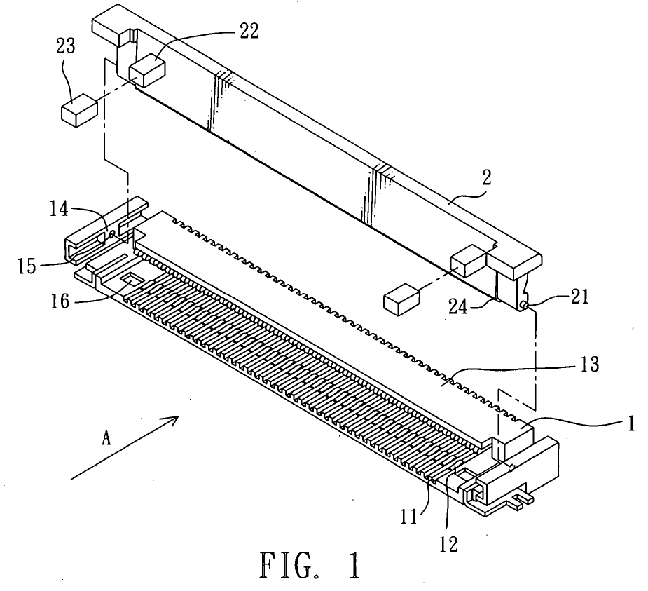

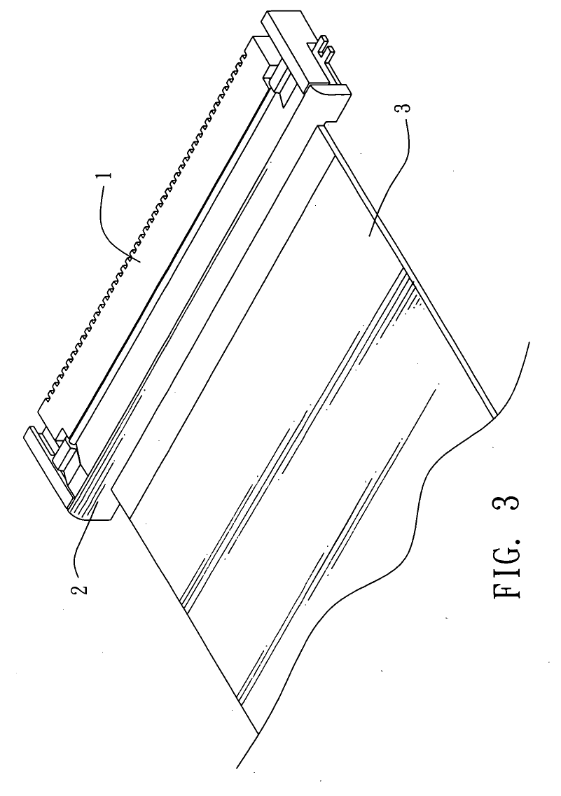

Referring to FIGS. 1 to 5, the connector of the present invention comprises a base 1, an upper casing 2, and a flat cable 3, and the flat cable 3 could be a flexible flat cable (FFC) or a flexible printed circuit (FPC). The base 1 is made of an insulating material and includes a plurality of terminal slots 11 proximate to an operating end A for receiving a plurality of terminals 12, and the rear section of the base 1 is covered by a base cover 13, such that the terminal slots 11 and the terminals 12 are not exposed. A sidewall 14 is disposed separately on both sides of the base 11, and the sidewall 14 is in the shape of a single pillar or track, so that the sidewall 14 can be pivotally connected with an upper casing 2. The sidewall 14 further comprises a pivoting member 15, and the pivoting member 15 is a hole in this preferred embodiment, but also could be a tenon.

The characteristics of the present invention reside on that a positioning member 16 is installed between the terminal slots 11 and sidewalls 14 disposed on both sides of the base 1, and the positioning member 16 is a penetrating or a non-penetrating hole groove, including and not limited to a protrusion, and the shape of the positioning member 16 includes but not limited to a rectangular shape, a circular shape, or any other shape.

The upper casing 2 is in the shape of a long bar and has a size corresponding to the exposed portion of the terminal slots 11, so that the upper casing 2 can cover the terminal slots 11 after the upper casing 2 is engaged. A pivoted member 21 disposed corresponding to the pivoting member 15 is selectively and pivotally coupled to a side of the upper casing. The pivoted member 21 according to this preferred embodiment is a tenon, but not limited to such. If the foregoing pivoting member 15 is a tenon, then the pivoted member 21 is a corresponding hole, and the pivoting member 15 preferably includes a resilient member such as a spring for reinforcing the engagement between the pivoting member 15 and the pivoted member 21. Further, a positioned member 22 is installed at a position corresponding to the positioning member 16, and the size and shape of the positioned member 22 correspond to those of the tenon of the positioning member 16. If the positioning member 16 is a tenon, then the positioned member 22 is a hole groove. To securely latch the positioning member 16 with the positioned member 22, the positioned member 22 includes a latch 23 as shown in the figure. The latch 23 is a binder made of a soft material, which can be sheathed directly onto the positioned member 22 or a notch is formed on the positioned member 22, so that when the positioned member is latched to the positioning member 16, the latch 23 presses against the positioning member 16 to secure the connection. However, such arrangement is a prior art, and thus will not be described here. Further, a pressing edge 24 is protruded from the sidewall for connecting the upper casing 2 to the lateral side of the base casing 13 for pressing the flat cable after the upper casing 2 is engaged with the base casing 13.

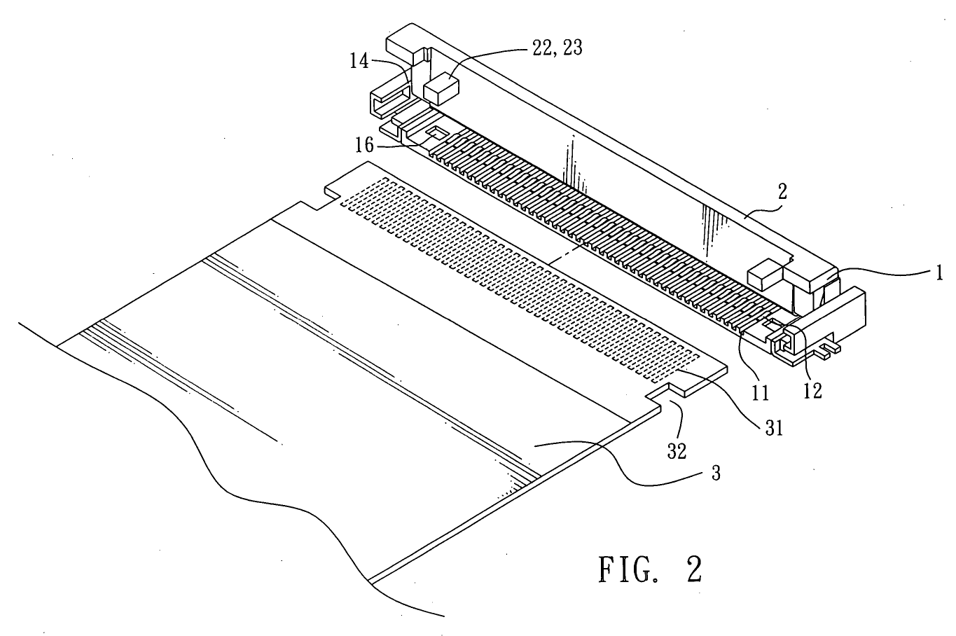

In FIG. 2, the front end of the flat cable 3 includes a plurality of flat cable terminals 31 coupled with the corresponding terminals 12 for providing an electric connection, after the flat cable terminals 31 are coupled with the terminals 12. At least one penetrating groove 32 is disposed at a position corresponding to the positioning member 16 for passing the positioned member 22. The penetrating groove 32 is a notch in this preferred embodiment, but it also could be a hole.

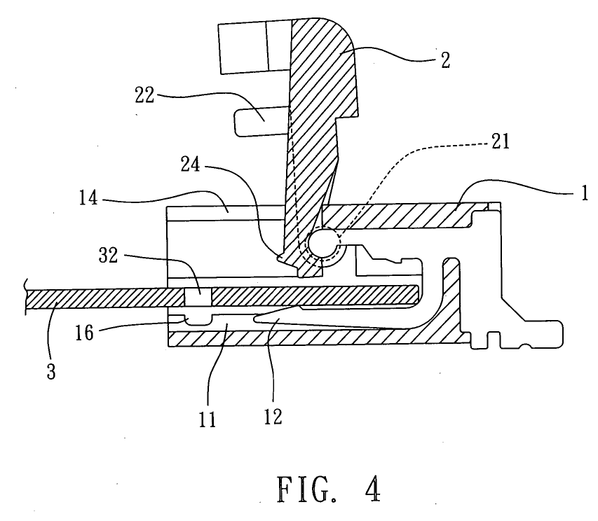

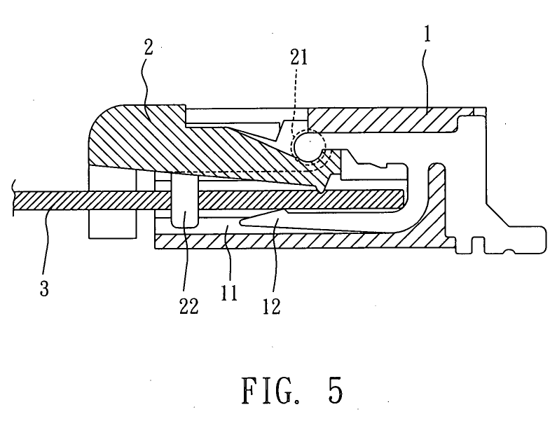

Referring to FIGS. 4 and 5 for the application of the present invention, the pivoted member 21 can be pivotally coupled to the pivoting member 15, so that the upper casing 2 can be lifted up from the base 1, and then the flat cable 3 in place at the exposed section of the base 1, and the flat cable terminals 31 correspond to the terminals 12 of the base 1, and then the upper casing 2 is turned downward to engage with the base 1. The positioned member 22 passes through the penetrating groove 32 and is embedded into the positioning member 16 for the positioning. In FIG. 5, the pressing edge 24 presses against the portion of the flat cable terminals 31 of the flat cable 3 for a secured connection. If the latch 23 is installed, then the upper casing 2 and the base 1 can be connected more securely.

In an application of the present invention, the connector of a flexible flat cable is connected securely for an electric connection. When the connector is being latched, the users can feel the snap-in movement. In the meantime, the invention can improve the pulling and pushing stresses of the FFC, and the flat cable can be accessed vertically downward, so as to prevent any possible scratch or damage to the goldfingers.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A connector, being installed onto a flat cable and comprising:
a base, having a plurality of terminal slots disposed at an operating end for receiving a plurality of terminals, and a pivoting member disposed separately on both sides of said base, and a positioning member disposed on both external sides of said terminal slots; and
an upper casing, having a pivoted member pivotally coupled with said pivoting member, and a positioned member disposed at a position corresponding to said positioning member;
such that said flat cable is clamped between said base and said upper casing by a penetrating groove disposed corresponding to said positioning member, and said positioned member passes through said penetrating groove to couple with said positioning member.

2. The connector of claim 1, wherein said base has a rear section covered by a base casing to prevent said terminal slots and said terminals from being exposed.

3. The connector of claim 2, wherein said upper casing is coupled to a side of said base casing and includes a pressing edge protruded from the side of said base casing.

4. The connector of claim 1, wherein said flat cable is a flexible flat cable.

5. The connector of claim 1, wherein said flat cable is a flexible printed circuit.

6. The connector of claim 1, wherein said pivoting member is a hole and said pivoted member is a tenon,

7. The connector of claim 1, wherein said positioning member is a hole groove and said positioned member is a protrusion.

8. The connector of claim 1, wherein said positioning member or said positioned member further comprises a latch.

9. The connector of claim 8, wherein said latch is a notch.

10. The connector of claim 8, wherein said latch is a soft binder.
